(19) United States
(12) Patent Application Publication
(10) Pub. No.: US 2009/0325419 A1
(43) Pub. Date: Dec. 31, 2009

(54) INFORMATION PROCESSING APPARATUS AND DISPLAY DEVICE

(75) Inventor: Masami Oosawa, Kumagaya-shi (JP)

Correspondence Address: PATTERSON & SHERIDAN, L.L.P., 3040 POST OAK BOULEVARD, SUITE 1500, HOUSTON, TX, 77056, US

(73) Assignee: Kabushiki Kaisha Toshiba, Tokyo (JP)

(21) Appl. No.: 12/419,641

(22) Filed: Apr. 7, 2009

(30) Foreign Application Priority Data
Jun. 30, 2008 (JP) 2008-170974

(51) Int. Cl. H01R 13/73

(52) U.S. Cl. 439/544

(57) ABSTRACT

According to one embodiment, an information processing apparatus includes a metal casing mounted on a base plate, a circuit board housed in the casing, and a connector to which a signal cable is detachably connected. The casing has a cover surface that covers the circuit board from the side opposite to the base plate and a connector mount section that is stepped from the cover surface toward the base plate. The connector is secured onto the bottom of the connector mount section.

### CROSS-REFERENCE TO RELATED APPLICATIONS

This application is based upon and claims the benefit of priority from Japanese Patent Application No. 2008-170974, filed Jun. 30, 2008, the entire contents of which are incorporated herein by reference.

### BACKGROUND

1. Field

One embodiment of the invention relates to an information processing apparatus in which a coaxial connector for connecting an antenna cable or the like thereto is fixed onto a metal casing. The present invention also relates to a display device such as a flat screen television on which a tuner module is mounted, especially to a structure that reinforces the thin display device.

2. Description of the Related Art

Flat screen televisions such as liquid crystal display televisions and plasma display panel televisions comprise a housing to house main components such as a display panel. The housing is composed of a front cover and a back cover that covers the front cover from behind. A tuner module that receives television signals is provided between the back cover and the display panel. The tuner module is mounted on a TV circuit board arranged on the back of the display panel.

The tuner module comprises a circuit board that includes a tuner circuit, a metal casing that houses this circuit board, and an antenna terminal to which an antenna cable is detachably connected. In general, a coaxial connector is adopted for the antenna terminal. The coaxial connector is fixed to the casing.

In an effort to improve the commercial value, the trend of flat screen televisions has been toward a thinner housing. To comply with this trend of thinner housings, a so-called horizontal-type tuner module is adopted in which the circuit board is arranged in parallel with the display panel.

As disclosed, for example, in Jpn. Pat. Appln. KOKAI Publication No. 2006-60474, the tuner module of the above type has a flat, rectangular box casing. The casing includes a flat cover that covers the circuit board. This cover opposes the back cover of the housing. The coaxial connector is fixed onto the cover of the casing.

According to the above Japanese patent publication, the coaxial connector of the tuner module protrudes upright from the cover of the casing. For this reason, when the module is housed in the housing of the flat screen television, the coaxial connector protrudes from the cover of the casing toward the back cover of the housing. Thus, it is possible that the thickness of the tuner module, which is the total length of the thickness of the casing and the length of the coaxial connector, becomes larger than the distance between the TV circuit board and the back cover.

In such a case, the coaxial connector is forced to penetrate the back cover and protrude from the back of the housing. In other words, as the housing becomes thinner, the coaxial connector protrudes from the back cover to a greater extent, posing a greater impediment to the slimming down of flat screen televisions.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of a flat screen television according to a first embodiment of the invention;

FIG. 2 is an exemplary perspective view of the flat screen television viewed from behind according to the first embodiment of the invention;

FIG. 3 is an exemplary perspective view of a tuner module according to the first embodiment of the invention;

FIG. 4 is an exemplary exploded perspective view of a casing that supports a coaxial connector according to the first embodiment of the invention;

FIG. 5 is an exemplary cross-sectional view of the tuner module in which the coaxial connector is secured onto the connector mount section of the casing according to the first embodiment of the invention;

FIG. 6 is an exemplary developed plan view of the frame of the casing according to the first embodiment of the invention;

FIG. 7 is an exemplary cross-sectional view of the flat screen television according to the first embodiment of the invention, indicating the positional relationship between the back cover of the housing and the coaxial connector of the tuner module;

FIG. 8 is an exemplary cross-sectional view of a tuner module in which the coaxial connector is secured onto the connector mount section of the casing according to a second embodiment of the invention;

FIG. 9 is an exemplary cross-sectional view of a tuner module in which the coaxial connector is secured onto the connector mount section of the casing according to a third embodiment of the invention; and

FIG. 10 is an exemplary perspective view of a tuner module according to a fourth embodiment of the present invention.

### DETAILED DESCRIPTION

Various embodiments according to the invention will be described hereinafter with reference to the accompanying drawings. In general, according to one embodiment of the invention, an information processing apparatus comprises: a metal casing mounted on a base plate; a circuit board housed in the casing; and a connector provided in the casing in such a manner that a signal cable is detachably connected thereto. The casing has a cover surface that covers the circuit board from the side opposite to the base plate and a connector mount section that is stepped from the cover surface toward the base plate. The connector is secured onto the bottom of the connector mount section.

According to another embodiment of the invention, a display device comprises: a housing having a back cover; a display panel housed in the housing; and a tuner module housed in the housing and arranged between the back cover and the display panel. The tuner module comprises a metal casing and a connector provided in the casing in such a manner as to protrude from the back cover so that a signal cable is detachably connected thereto. The casing has a cover surface that faces the back cover and a connector mount section that is stepped from the cover surface in a direction away from the back cover. The connector is secured onto the bottom of the connector mount section.

A first embodiment of the invention will be explained with reference to FIGS. 1 to 7.

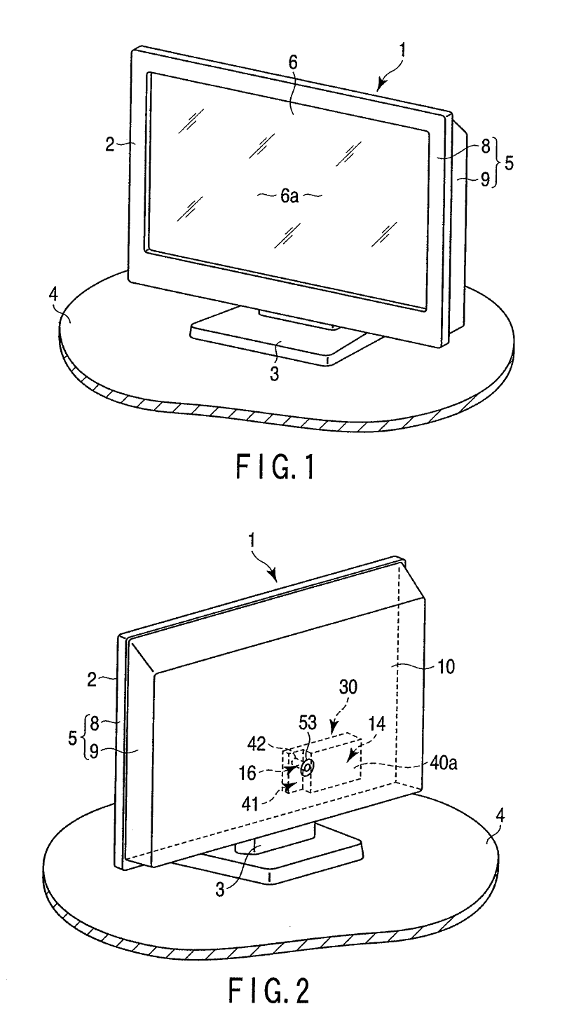

FIGS. 1 and 2 show a flat screen television 1, which is an example of a display device. The flat screen television 1 comprises a flat television main body 2 and a stand 3 that supports the television main body 2. The stand 3 is placed on a placement surface 4, such as a TV stand.

The television main body 2 includes a housing 5 made of a synthetic resin and a flat display panel 6 housed in the housing 5. The display panel 6 has a rectangular display screen 6a, and stands upright inside the housing 5. The display screen 6a is exposed to the outside from the front side of the housing 5.

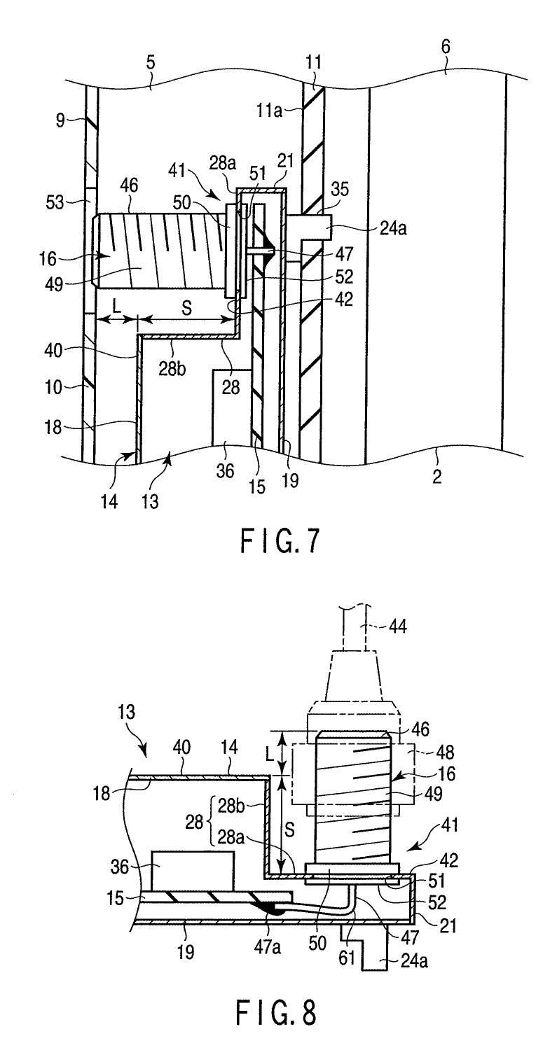

As illustrated in FIGS. 1 and 2, the housing 5 includes a front cover 8 and a back cover 9. The front cover 8 surrounds the display screen 6a of the display panel 6. As illustrated in FIG. 7, the back cover 9 covers the display panel 6 from behind.

The back cover 9 has a back wall 10. The back wall 10 stands upright behind the display panel 6. A TV circuit board 11 is provided between the back wall 10 and the display panel 6. The TV circuit board 11 stands upright, facing the back wall 10. The TV circuit board 11 and the display panel 6 are supported by the back cover 9 by way of a metallic chassis that is not shown in the drawings.

The TV circuit board 11 includes a mount surface 11a. The mount surface 11a faces the back wall 10 of the back cover 9. A tuner module 13 that receives a television signal is mounted on the mount surface 11a of the TV circuit board 11. The tuner module 13 is an example of the information processing apparatus, and is provided between the back wall 10 of the back cover 9 and the TV circuit board 11.

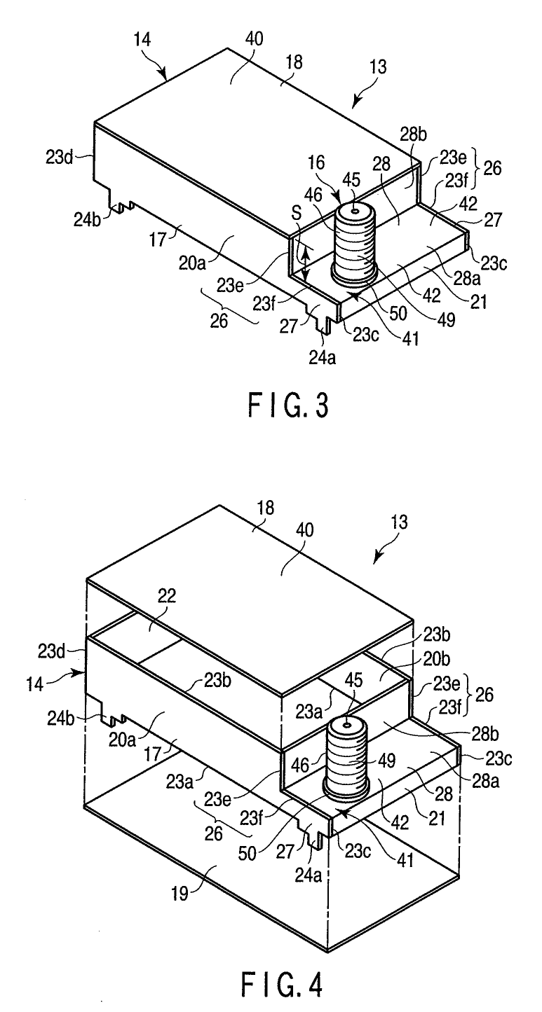

FIGS. 3 to 5 show the structure of the tuner module 13 in detail. The tuner module 13 includes a metal casing 14, a circuit board 15 on which a tuner circuit is mounted, and a coaxial connector 16 that serves as an antenna terminal.

The casing 14 has an electromagnetic shield function. The casing 14 is shaped into a flat, substantially rectangular box. The thickness direction of the casing 14 agrees with the thickness direction of the housing 5. The casing 14 is composed of three components, a frame 17, a top plate 18 and a bottom plate 19. The frame 17 includes a pair of side plates 20a and 20b, a first end plate 21 and a second end plate 22.

The side plates 20a and 20b are each shaped into a rectangle elongated in the width direction of the back cover 9, and positioned a certain distance apart from each other in the height direction of the back cover 9 and in parallel with each other. Each of the side plates 20a and 20b has first to fourth edges 23a, 23b, 23c and 23d. The first edge 23a extends along the mount surface 11a of the TV circuit board 11. The second edge 23b extends on the side opposite to the first edge 23a, in parallel with the first edge 23a. The third edge 23c extends between the ends of the side plates 20a and 20b in the thickness direction of the casing 14. The fourth edge 23d extends between the other ends of the side plates 20a and 20b in the thickness direction of the casing 14.

Furthermore, each of the side plates 20a and 20b has a pair of engagement pieces 24a and 24b. The engagement pieces 24a and 24b protrude from the first edge 23a and are positioned a certain distance apart from each other in the longitudinal direction of the side plates 20a and 20b.

A notch 26 is formed on one end of each of the side plates 20a and 20b in their longitudinal direction. The notch 26 is defined by a fifth edge 23e and a sixth edge 23f. The fifth edge 23e extends from one end of the second edge 23b of each of the side plates 20a and 20b towards the first edge 23a. The sixth edge 23f extends in parallel with the first edge 23a of the side plates 20a and 20b from the end of the fifth edge 23e. Thus, the side plates 20a and 20b form, at one end thereof, a narrow portion 27 cut out in such a manner as to reduce the thickness of the casing 14.

The first end plate 21 is provided between the third edges 23c of the side plates 20a and 20b. The first end plate 21 has an extended portion 28 provided between the notches 26 of the side plates 20a and 20b. The extended portion 28 includes a first plate 28a and a second plate 28b. The first plate 28a is provided between the sixth edges 23f of the side plates 20a and 20b. The second plate 28b is provided between the fifth edges 23e of the side plates 20a and 20b. The first plate 28a and the second plate 28b are orthogonal to each other.

The second end plate 22 is provided between the fourth edges 23d of the side plates 20a and 20b. Thus, the first end plate 21 and the second end plate 22 is opposite to each other in the longitudinal direction of the side plates 20a and 20b.

According to the present embodiment, the frame 17 is formed into a rectangular-frame shape by folding a metal plate 30 that is prepared by a blanking process as illustrated in FIG. 6. As can be seen from this drawing, the metal plate 30 includes first plate elements 31a and 31b which correspond to the side plates 20a and 20b, a second plate element 32 which corresponds to the first end plate 21 and the extended portion 28, and a third plate element 33 which corresponds to the second end plate 22. Each adjacent pair of the plate elements 31a, 31b, 32 and 33 is attached with a coupling portion 34.

The procedure of assembling the metal plate 30 into the frame 17 will now be explained. First, as shown in FIG. 6, the first plate elements 31a and 31b are bent along two bend lines X1 extending parallel to each other so that the two elements face each other. Then, the second plate element 32 and the third plate element 33 are bent along two bend lines X2 extending parallel to each other so that the two elements face each other.

Next, the edges of the first plate elements 31a and 31b that are bent and the edges of the second plate element 32 that is bent are put together and attached by means of calking or the like. In the same manner, the edges of the first plate elements 31a and 31b that are bent and the edges of the third plate element 33 that are bent are put together and attached by means of calking or the like.

Next, the second plate element 32 is bent along a bend line X3 to form the first plate 28a. Further, the second plate element 32 is bent along a bend line X4 to form the second plate 28b.

Thereafter, the edges of the first plate 28a are put together with the sixth edges 23f of the side plates 20a and 20b and attached by means of calking or the like. Further, the edges of the second plate 28b are put together with the fifth edges 23e of the side plates 20a and 20b and attached by means of calking or the like. As a result, the side plates 20a and 20b, the first end plate 21 and the second end plate 22 are put into a rectangular frame, and the assembly of the frame 17 is completed.

As illustrated in FIG. 4, the top plate 18 is fixed onto the frame 17 in such a manner as to cover the opening surrounded by the side plates 20a and 20b, the second plate 28b of the extended portion 28, and the second end plate 22. Similarly, the bottom plate 19 is fixed onto the frame 17 in such a manner as to cover the opening surrounded by the side plates 20a and 20b, the first end plate 21 and the second end plate 22. The top plate 18 and the bottom plate 19 face each other in the thickness direction of the casing 14.

As illustrated in FIG. 7, the engagement pieces 24a and 24b of the frame 17 are inserted into slits 35 (one shown in FIG. 7) formed in the TV circuit board 11 and soldered to the TV circuit board 11. In this manner, the casing 14 is secured onto the mount surface 11a of the TV circuit board 11. With the casing 14 secured onto the TV circuit board 11, the top plate 18 of the casing 14 faces the back wall 10 of the back cover 9.

The circuit board 15 carries various circuit components 36 that constitute the tuner circuit. The circuit board 15 is placed in parallel with the top plate 18 and the bottom plate 19 in the casing 14.

The top plate 18 of the casing 14 has a cover surface 40. The cover surface 40 covers the circuit board 15 from the direction of the back wall 10 of the back cover 9. In other words, the cover surface 40 covers the circuit board 15 in the direction opposite to the TV circuit board 11.

Furthermore, the casing 14 includes a connector mount section 41 that is stepped down from the cover surface 40 toward the TV circuit board 11. The connector mount section 41 is defined by the notches 26 of the side plates 20a and 20b of the frame 17 and the extended portion 28 of the first end plate 21.

The first plate 28a of the extended portion 28 is positioned at the bottom of the connector mount section 41, forming a flat support surface 42 in the bottom of the connector mount section 41. The support surface 42 is receded from the back wall 10 of the back cover 9 and placed closer to the TV circuit board 11 than to the cover surface 40.

When the casing 14 is viewed from a different angle, the connector mount section 41 is positioned at one end of the cover surface 40. Furthermore, the support surface 42 of the connector mount section 41 extends in parallel with the TV circuit board 11 from a position closer to the TV circuit board 11 than to the cover surface 40.

For this reason, a step S is created between the support surface 42 and the cover surface 40 in the thickness direction of the casing 14. Thus, the thickness of the casing 14 is reduced most in the area corresponding to the connector mount section 41.

The coaxial connector 16 is provided to connect an antenna cable 44, which serves as a signal cable, in a detachable manner. As shown in FIGS. 3 to 5, the coaxial connector 16 includes an insertion hole 45 to which the cable core of the antenna cable 44 is inserted, an outer conductor 46 that cylindrically surrounds the insertion hole 45, and a central conductor 47 that is electrically connected to the cable core. An external tread 49 onto which a cable fitting 48 provided on the antenna cable 44 is screwed and a flange 50 which protrudes from the outer circumferential surface of the outer conductor 46 are formed on the outer circumferential surface of the outer conductor 46.

The coaxial connector 16 is inserted into a through hole 51 formed in the support surface 42 from the outside of the casing 14. By this insertion, the flange 50 is pressed against the support surface 42. Moreover, the tip of the outer conductor 46 is broadened by means of calking or the like after the coaxial connector 16 is inserted into the through hole 51. As a result, a stopper 52 is formed at the tip of the outer conductor 46 in such a manner as to stretch in the radial direction. The stopper 52 sandwiches the first plate 28a of the frame 17 together with the flange 50. Thus, the coaxial connector 16 is secured onto the support surface 42 of the connector mount section 41, and protrudes from this support surface 42 in the direction opposite to the TV circuit board 11. In other words, the coaxial connector 16 extends from the support surface 42 of the connector mount section 41 toward the back wall 10 of the back cover 9.

The central conductor 47 of the coaxial connector 16 is guided straight in the axial direction of the outer conductor 46 and connected to the circuit board 15 by means of soldering or the like.

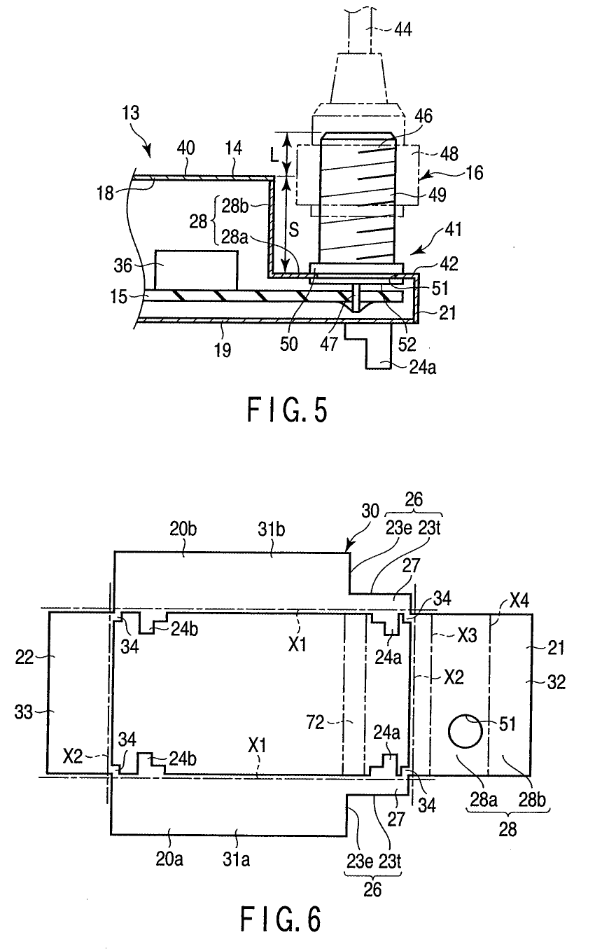

As shown in FIG. 5, the coaxial connector 16 has a greater length than the step S of the casing 14. With this arrangement, the coaxial connector 16 extends out from the cover surface 40 of the casing 14 toward the back cover 9. The protrusion length L of the coaxial connector is calculated by subtracting the step S from the entire length of the coaxial connector 16.

As shown in FIG. 7, the back wall 10 of the back cover 9 has an opening 53 through which the antenna cable 44 can be drawn. The opening 53 faces the leading end of the coaxial connector 16. According to the present embodiment, the leading end of the coaxial connector 16 is positioned inside the housing 5 with reference to the back wall 10 of the back cover 9.

According to the first embodiment, the connector mount section 41 is formed as a step in the cover surface 40 of the casing 14 of the tuner module 13 in such a manner as to be receded from the back cover 9 of the housing 5. The connector mount section 41 includes the flat support surface 42 at its bottom. The coaxial connector 16 that serves as an antenna terminal is secured onto the support surface 42 in the bottom of the connector mount section 41.

In this structure, the step S is created between the cover surface 40 of the casing 14 and the support surface 42 of the connector mount section 41 in the thickness direction of the casing 14. Thus, the protrusion length L of the coaxial connector 16 with reference to the cover surface 40 is a value obtained by subtracting the step S from the entire length of the coaxial connector 16.

As a result, the protrusion length of the coaxial connector 16 from the cover surface 40 is reduced by the length of the step S, which prevents the coaxial connector 16 from extending out of the back cover 9 to a large extent. Thus, a thin, compact tuner module 13 can be produced.

In particular, according to the present embodiment, the leading end of the coaxial connector 16 is recessed inside the housing 5 with respect to the opening 53 of the back cover 9. Hence, the flatness of the flat screen television 1 can be improved without the coaxial connector 16 sticking out from the back cover 9, and thereby the commercial value of the flat screen television 1 can be enhanced.

The present invention is not limited to the first embodiment, but can be realized with various modifications without departing from the scope of the invention.

For example, according to the first embodiment, the leading end of the coaxial connector is recessed inside the housing with respect to the opening. However, the leading end of the coaxial connector may extend out of the housing with respect to the opening. With the leading end of the coaxial connector arranged outside the housing, the workability of connecting the cable fitting to the coaxial connector can be improved.

The number of coaxial connectors is not limited to one, and multiple coaxial connectors may be arranged in line and fixed onto the support surface of the connector mount section.

FIG. 8 shows a second embodiment of the present invention.

The arrangement of the second embodiment differs from that of the first embodiment in the connection of the central conductor 47 of the coaxial connector 16 to the circuit board 15. The rest of the structure of the tuner module 13 is the same as that of the first embodiment.

As illustrated in FIG. 8, the edge of the circuit board 15 does not extend to the area beneath the coaxial connector 16 in the casing 14, but is away from the coaxial connector 16 in the longitudinal direction of the casing 14. The central conductor 47 of the coaxial connector 16 is formed of, for example, a belt-like metal plate that can be elastically deformed. The central conductor 47 is pulled down straight in the axial direction of the outer conductor 46, and then bent toward the edge of the circuit board 15. The leading end 47a of the central conductor 47 is attached to the circuit board 15 by means of soldering or the like. Thus, the central conductor 47 has a bend portion 61 that can be elastically deformed in an arc shape at a position closer to the outer conductor 46 than to the leading end 47a. The bend portion 61 is arranged between the leading end 47a of the central conductor 47 and the outer conductor 46.

The second embodiment offers the following advantages over the first embodiment.

According to the first embodiment, the central conductor 47 of the coaxial connector 16 extends straight in the axial direction of the outer conductor 46 and is soldered to the circuit board 15. In this structure, the soldered portion of the central conductor 47 and the circuit board 15 is positioned on the axis line of the coaxial connector 16. For this reason, after the operations of putting the antenna cable 44 into and pulling it out of the coaxial connector 16 are repeated, the force applied to the antenna cable 44 that is put in and pulled out directly acts onto the soldered portion of the central conductor 47 and the circuit board 15. Furthermore, because the central conductor 47 thermally expands and contracts in accordance with changes in the ambient temperature, stress is produced on the soldered portion of the central conductor 47 and the circuit board 15.

Hence, when the long-term use of the tuner module 13 is considered, a crack may appear in the soldered portion of the central conductor 47 and the circuit board 15, which would lower the reliability of the soldering.

In contrast, according to the second embodiment, the elastically deformable bend portion 61 is provided in the middle of the central conductor 47. This bend portion 61 is positioned toward the coaxial connector 16 with respect to the leading end 47a of the central conductor 47 that is soldered to the circuit board 15. For this reason, when the force exerted on the antenna cable 44 that is inserted and pulled out is conveyed to the central conductor 47, or when the central conductor 47 thermally expands or contracts, the bend portion 61 is elastically bent so that the force exerted on the antenna cable 44 or the expansion and contraction of the central conductor 47 can be absorbed.

In this manner, the present embodiment avoids the application of excessive stress to the soldered portion of the central conductor 47 and the circuit board 15. Thus, the electrical connection between the central conductor 47 and the circuit board 15 can be reliably achieved.

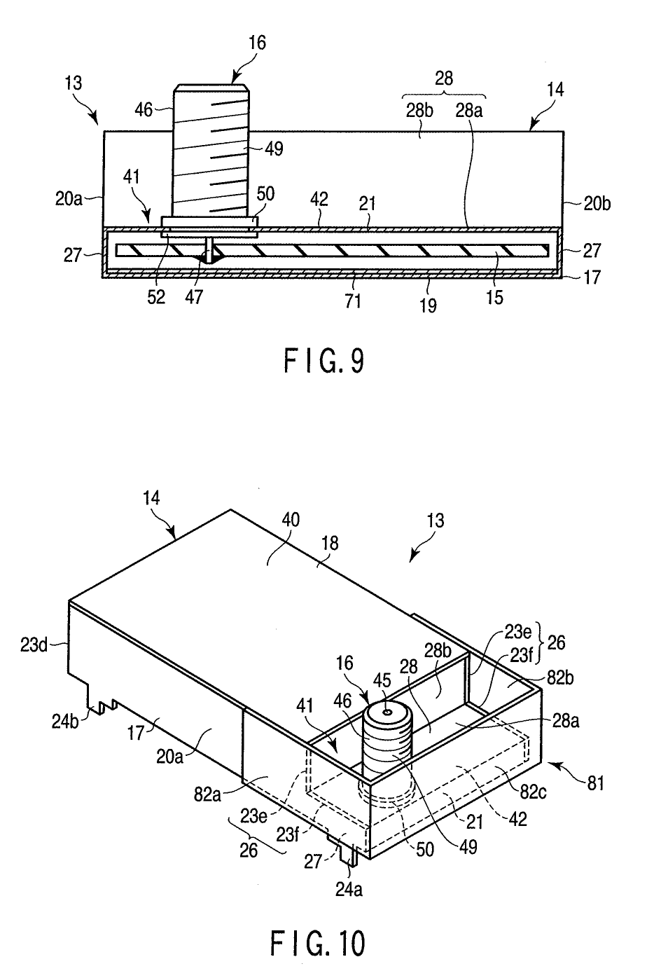

FIG. 9 shows a third embodiment of the present invention.

The third embodiment differs from the first embodiment in the arrangement of the connector mount section 41 of the casing 14. The rest of the structure of the tuner module 13 is the same as that of the first embodiment.

As illustrated in FIG. 9, the frame 17 includes a bridge 71 as a reinforcing means. The bridge 71 is provided in the narrow portion 27 between the side plates 20a and 20b. The bridge 71 faces the first plate 28a of the first end plate 21, which forms the support surface 42 of the connector mount section 41. The bridge 71 connects the side plates 20a and 20b to each other in the narrow portion 27 so as to reinforce the connector mount section 41.

It is desirable that the bridge 71 be prepared in advance uniformly from the metal plate 30, which is the basic form of the frame 17, as a belt-like plate element 72 indicated by a chain double-dashed line in FIG. 6. The plate element 72 is provided between the plate elements 31a and 31b, and it serves as the bridge 71 by bending the plate elements 31a and 31b in such a manner as to face each other.

In such an arrangement, the connector mount section 41 can be reinforced by connecting the side plates 20a and 20b with the bridge 71. For this reason, despite the thickness of the casing 14 that is reduced at the connector mount section 41, the strength of the connector mount section 41 can be increased. Thus, when putting the antenna cable 44 in and pulling it out of the coaxial connector 16, the structure is protected against the force exerted on the connector mount section 41.

FIG. 10 shows a fourth embodiment of the present invention.

The fourth embodiment differs from the first embodiment in that the connector mount section 41 of the casing 14 is reinforced by way of a specially designed reinforcing frame 81. The rest of the structure of the tuner module 13 is the same as that of the first embodiment.

As illustrated in FIG. 10, the reinforcing frame 81, which is an example of a reinforcing means, includes first to third reinforcing plates 82a, 82b and 82c. The first to third reinforcing plates 82a, 82b and 82c each have a rectangular shape of the same width as the thickness of the casing 14. The first and second reinforcing plates 82a and 82b face each other in the width direction of the casing 14. The third reinforcing plate 82c is provided between the edges of the first and second reinforcing plates 82a and 82b so as to connect the reinforcing plates 82a and 82b to each other.

The first reinforcing plate 82a is secured onto the outside surface of the side plate 20a of the frame 17 by means of calking or the like so as to cover the narrow portion 27 of the side plate 20a. In the same manner, the second reinforcing plate 82b is secured onto the outside surface of the side plate 20b of the frame 17 by means of calking or the like so as to cover the narrow portion 27 of the side plate 20b. The third reinforcing plate 82c is secured onto the outside surface of the first end plate 21 of the frame 17 by means of calking or the like so as to cover the outside surface.

Thus, the connector mount section 41 is surrounded by the reinforcing frame 81 that has the same width as the thickness of the casing 14.

In the structure in which the connector mount section 41 is surrounded by the reinforcing frame 81, the connector mount section 41 is reinforced from the outside of the casing 14. For this reason, despite the thickness of the casing 14 that is reduced in the area of the connector mount section 41, the strength of the connector mount section 41 is increased. Hence, the connector mount section 41 is sufficiently protected against the force exerted on the connector mount section 41 when the antenna cable 44 is put into and pulled out of the coaxial connector 16.

According to the fourth embodiment, the connector mount section is reinforced from the outside of the casing, but the present invention is not limited thereto. For example, a reinforcement body of a truss structure may be provided between the first plate in the bottom of the connector mount section and the bottom plate so that the connector mount section can be reinforced from the inside of the casing.

While certain embodiments of the inventions have been described, there embodiments have been presented by way of example only, and are not intended to limit the scope of the invention. Indeed, the novel methods and systems described herein may be embodied in a variety of other forms; furthermore various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a metal casing mounted on a base plate;
a circuit board housed in the casing; and
a connector provided in the casing in such a manner that a signal cable is detachably connected thereto,
wherein the casing has a cover surface that covers the circuit board from a side opposite to the base plate and a connector mount section that is stepped from the cover surface toward the base plate; and
the connector is secured onto a bottom of the connector mount section.

2. The information processing apparatus of claim 1, wherein the connector protrudes from the bottom of the connector mount section in a direction opposite to the base plate.

3. The information processing apparatus of claim 2, wherein the connector is a coaxial connector, which has a cylindrical outer conductor secured onto the bottom of the connector mount section and a central conductor drawn out of the outer conductor and connected to the circuit board.

4. The information processing apparatus of claim 3, wherein the central conductor has a leading end that is connected to the circuit board and a bend portion that is elastically deformable.

5. The information processing apparatus of claim 4, wherein the bend portion is positioned between the leading end of the central conductor and the outer conductor.

6. The information processing apparatus of claim 1, wherein:
the connector mount section has a support surface provided toward the base plate with respect to the cover surface;
a step is created between the support surface and the cover surface in a thickness direction of the casing; and
the connector is secured onto the support surface.

7. The information processing apparatus of claim 6, wherein the casing is formed in such a manner that a portion thereof that corresponds to the connector mount section has a smallest thickness.

8. The information processing apparatus of claim 7, further comprising reinforcing means that reinforces the connector mount section of the casing.

9. An information processing apparatus comprising:
a metal casing mounted on a base plate;
a circuit board housed in the casing; and
a connector provided in the casing in such a manner that a signal cable is detachably connected thereto,
wherein the casing has a cover surface that covers the circuit board from a side opposite to the base plate and a support surface that is positioned at one end of the cover surface and protrudes from a position toward the base plate with respect to the cover surface;
a step is created in a thickness direction of the casing between the support surface and the cover surface; and
the connector is secured onto the support surface.

10. The information processing apparatus of claim 9, wherein the connector protrudes from the support surface in a direction opposite to the base plate.

11. The information processing apparatus of claim 10, further comprising reinforcing means that reinforces the support surface of the casing.

12. The information processing apparatus of claim 9, wherein:
the connector is a coaxial connector, which has a cylindrical outer conductor secured onto the support surface and a central conductor drawn out of the outer conductor and connected to the circuit board; and
the central conductor has a leading end that is connected to the circuit board and a bend portion that is elastically deformable.

13. The information processing apparatus of claim 12, wherein the bend portion is provided toward the outer conductor with respect to the leading end of the central conductor.

14. A display device comprising:
a housing having a back cover;
a display panel housed in the housing; and
a tuner module provided in the housing and arranged between the back cover and the display panel,
wherein the tuner module comprises:
a metal casing; and
a connector provided in the casing in such a manner as to be exposed to an outside of the back cover so that a signal cable is detachably connected thereto,
the casing has a cover surface that faces the back cover and a connector mount section that is stepped from the cover surface in a direction away from the back cover, and the connector is secured onto a bottom of the connector mount section.

15. The display device of claim 14, wherein:
the connector mount section has a support surface provided closer to the display panel than to the cover surface;
a step is created between the support surface and the cover surface in a thickness direction of the housing; and
the connector is secured onto the support surface.

16. The display device of claim 15, wherein the connector protrudes from the support surface toward the back cover.

17. The display device of claim 16, wherein:
the back cover has an opening through which the signal cable is drawn at a position corresponding to the connector;
the connector has a leading end that faces the opening; and
the leading end of the connector is recessed into the housing with respect to the opening.

18. The display device of claim 14, wherein the casing is formed in such a manner that a portion thereof that corresponds to the connector mount section has a smallest thickness.

19. The display device of claim 14, further comprising reinforcing means that reinforces the connector mount section of the casing.
